(19) United States
(12) Patent Application Publication
(10) Pub. No.: US 2002/0023117 A1
(43) Pub. Date: Feb. 21, 2002

(54) Redundancy-based methods, apparatus and articles-of-manufacture for providing improved quality-of-service in an always-live distributed computing environment

(76) Inventors: James Bernardin, Brooklyn, NY (US); Peter Lee, New York, NY (US)

Correspondence Address: David Garrod, Ph.D., Esq., Hopgood, Calimafde, Judlowe & Mondolino, LLP, 60 East 42nd Street, New York, NY, 10165, US

(21) Appl. No.: 09/777,190

(22) Filed: Feb. 2, 2001

Related U.S. Application Data
(63) Continuation-in-part of application No. 09/583,244, filed on May 31, 2000.
(63) Continuation-in-part of application No. 09/711,634, filed on Nov. 13, 2000.

(51) Int. Cl. G06F 9/00

(52) U.S. Cl. 709/104; 709/226

(57) ABSTRACT

Improved methods, apparatus and articles-of-manufacture for providing distributed computing in a peer-to-peer network of processing elements utilize redundancy to improve quality-of-service and/or mitigate processing delays attributable to failures or slowdowns of processing elements or network connections.

### CROSS-REFERENCE TO RELATED APPLICATIONS

The present application is a continuation-in-part of U.S. patent application Ser. No. 09/583,244, filed May 31, 2000, by the inventors herein (“the '244 application”), which prior application is incorporated herein by reference. The present application is also a continuation-in-part of U.S. patent application Ser. No. 09/711,634, filed Nov. 13, 2000, by the inventors herein (“the '634 application”), which prior application is also incorporated herein by reference.

### FIELD OF THE INVENTION

The present invention relates generally to the fields of distributed computing methods, computer-assisted business methods, and systems and articles-of-manufacture for implementing such methods. More particularly, the invention relates to computer-based methods, apparatus and articles-of-manufacture for providing improved and/or guaranteed quality-of-service in an always-live, peer-to-peer distributed computing environment.

### BACKGROUND OF THE INVENTION

Methods for providing distributed computing in network-based computing environments (such as the Internet) are known. One widely-publicized effort was the so-called SETI@home (Search for Extra-Terrestrial Intelligence) project, in which large numbers of Internet-connected computers were used to process radio-telescope data, in an effort to identify patterns indicative of intelligent life. Other examples are described in U.S. Pat. No. 5,964,832 (“USING NETWORKED REMOTE COMPUTERS TO EXECUTE COMPUTER PROCESSING TASKS AT A PREDETERMINED TIME”), U.S. Pat. No. 6,098,091 (“METHOD AND SYSTEM INCLUDING A CENTRAL COMPUTER THAT ASSIGNS TASKS TO IDLE WORKSTATIONS USING AVAILABILITY SCHEDULES AND COMPUTATIONAL CAPABILITIES”) and U.S. Pat. No. 6,112,243 (“METHOD AND APPARATUS FOR ALLOCATING TASKS TO REMOTE NETWORKED PROCESSORS”), all owned by Intel Corporation. Still another example is disclosed in the earlier-filed '244 application by the inventors herein. (Note, however, that the '244 application is not prior art to the present invention.)

Generally speaking, the primary object of Internet-based distributed computing systems is to exploit the vast computational resources that sit idle for much of the 24-hour day on computer networks around the world. Although some success has been achieved, prior-art systems still have problems that limit their usefulness in real-world applications.

One particularly-troublesome aspect of the prior-art systems is their inability guarantee timely results. While it may be no problem for the SETI@home researchers to wait days or weeks for results from a particular data set, commercial customers simply cannot afford to have overnight processing jobs run unexpectedly into the next business day. Therefore, in order to realize the full commercial potential of network-based distributed computing, it is necessary to ensure that the clients' work gets processed in a substantially continuous and uninterrupted manner, so that a service provider can assure his/her clients that assigned work will be completed in within a commercially-reasonable time period (, an hour, four hours, eight hours, etc.).

The “always live” concept, introduced in the '634 application (which is not prior art to the present invention), significantly improves the ability of a network-based distributed computing system to assure substantial continuity in the processing of client jobs, thus greatly minimizing the probability of unexpected processing delays. Nevertheless, given the great importance that commercial clients attach to quality-of-service guarantees, there is still a need for further improvement. The present invention addresses this need.

### OBJECTS AND DESCRIPTION OF THE INVENTION

In light of the above, a first general object of the invention relates to computer-based methods, apparatus and articles-of-manufacture that facilitate quality-of-service in distributed computing systems, such as, but not limited to, an always-live distributed computing system.

A second general object of the invention relates to improved computer-based methods, apparatus and articles-of-manufacture that provide substantially continuous monitoring of worker processor activity and/or task progress in a distributed computing environment.

A third general object of the invention relates to improved computer-based methods, apparatus and articles-of-manufacture that provide prompt alerts of worker processor status changes that can affect the always-live operation of a network-based distributed computing system.

A fourth general object of the invention relates to computer-based methods, apparatus and articles-of-manufacture for providing reliable and/or predictable quality-of-service in a peer-to-peer network based distributed computing system.

These, as well as other objects and advantages of the present invention, will become apparent in light of the following description, which details, by way of illustrative examples, the various aspects and features of the present invention.

An important concept underlying the methods, apparatus and articles-of-manufacture of the present invention is the idea of using redundancy, either full or partial, to mitigate quality-of-service problems that plague many distributed computing approaches. In most distributed processing jobs, there will exist one or more “critical tasks” for which a delay in task completion can disproportionately affect the overall completion time for the job; in other words, a delay in completion of a critical task will have a greater effect than a comparable delay in completion of at least some other “non-critical” task. (Additionally, a “critical task” may be a task which, for whatever reason (e.g., historical behavior, need to retrieve data via unreliable connections, etc.), poses an enhanced risk of delay in completion, even if such delay will not disproportionately impact overall job completion.)

The present invention is based, at least in part, on the inventors' recognition that quality-of-service problems in distributed computing are frequently caused by delays in completing critical task(s), and that such quality-of-service problems can be effectively mitigated by through redundancy. One aspect of the invention provides methods, apparatus and articles-of-manufacture for assigning additional (i.e., redundant) resources to ensure timely completion of a job's critical task(s). Preferably, although not necessarily, only the critical task(s) receive redundant resource assignment; alternatively, a job's various tasks may be assigned redundant resources in accordance with their relative criticality—e.g., marginally critical tasks are each assigned to two processors, critical tasks are each assigned to three processors, and the most critical tasks are each assigned to four or more processors. Another aspect of the invention provides methods, apparatus and articles-of-manufacture for selectively assigning higher-capability (e.g., faster, more memory, greater network bandwidth, etc.) processing elements/resources to a job's more critical tasks.

Accordingly, generally speaking, and without intending to be limiting, one aspect of the invention relates to methods, apparatus or articles-of-manufacture for improving quality-of-service in a distributed computing system including, for example, a multiplicity of network-connected worker processors and at least one supervisory processor, the supervisory processor configured to assign tasks to the worker processors, the methods/apparatus/articles-of-manufacture involving, for example, the following: identifying one or more of the tasks as critical task(s); assigning each of the tasks, including the critical task(s), to a worker processor; redundantly assigning each of the one or more critical task(s) to a worker processor; and monitoring the status of the assigned tasks to determine when all of the tasks have been completed by at least one worker processor. The methods, apparatus or articles of manufacture may further involve monitoring, on a substantially continuous basis, the status of at least the worker processor(s) that have been assigned the non-critical task(s). Monitoring, on a substantially continuous basis, the status of at least the worker processor(s) that have been assigned the non-critical task(s) may include receiving status messages from at least each of the worker processor(s) that have been assigned non-critical task(s) until each the processor completes its assigned task. Monitoring, on a substantially continuous basis, the status of at least the worker processor(s) that have been assigned the non-critical task(s) may also involve detecting abnormalities in the operation of the worker processor(s) that have been assigned non-critical task(s), and/or their associated network connections, by detecting an absence of expected status message(s) received by the at least one supervisory processor. Such act of detecting an absence of expected status message(s) received by the at least one supervisory processor is preferably repeated at a preselected interval, such as at least once every ten minutes, at least once each minute, at least once each second, at least once every tenth of a second, or at any other appropriate interval selected to maintain an expected quality-of-service. Monitoring, on a substantially continuous basis, the status of at least the worker processor(s) that have been assigned the non-critical task(s) may also involve detecting the presence of non-assigned-task-related activity on at least the worker processor(s) that have been assigned the non-critical task(s). Detecting the presence of non-assigned-task-related activity may include running an activity monitor program on at least each of the worker processor(s) that have been assigned non-critical task(s). Such activity monitor programs may behave substantially like screen saver programs, and may be configured to send, in response to detection of keyboard activity, a message to at least one of the at least one supervisory processor(s). Such activity monitory programs may also be configured to send a message to at least one of the at least one supervisory processor(s) in response to detection of any of the following: (i) mouse activity; (ii) pointer activity; (iii) touchscreen activity; (iv) voice activity; and/or (v) execution of substantial non-assigned-task-related processes.

Again, generally speaking, and without intending to be limiting, another aspect of the invention relates to methods, apparatus or articles-of-manufacture for operating a peer-to-peer distributed computing system, involving, for example, the following: providing a pool of worker processors, each having installed worker processor software, and each connected to an always-on, peer-to-peer computer network; providing at least one supervisory processor, also connected to the always-on, peer-to-peer computer network; using the at least one supervisory processor to monitor the status of worker processors expected to be engaged in the processing of assigned tasks; and using the at least one supervisory processor to redundantly assign one more critical task(s) to one or more additional worker processors. Providing a pool of worker processors may also involve ensuring that each of the worker processors is linked to the always-on, peer-to-peer computer network through a high-bandwidth connection at, for example, a data rate of at least 100 kilobits/sec, at least 250 kilobits/sec, at least 1 megabit/sec, at least 10 megabits/sec, at least 100 megabits/sec, or at least 1 gigabit/sec. Using the at least one supervisory processor to monitor the status of worker processors expected to be engaged in the processing of assigned tasks may include sending a status-request message to, and receiving a return acknowledgement from, each worker processor that is expected to be engaged in the processing of assigned tasks. The process of sending a status-request message to, and receiving a return acknowledgement from, each worker processor that is expected to be engaged in the processing of assigned tasks is preferably repeated on a regular basis, such as at least once every second, at least once every tenth of a second, at least once every hundredth of a second, or at least once every millisecond. Using the at least one supervisory processor to monitor the status of worker processors expected to be engaged in the processing of assigned tasks may involve periodically checking to ensure that a heartbeat message has been received, within a preselected frequency interval, from each worker processor that is expected to be engaged in the processing of assigned tasks. The preselected frequency interval may be less than ten minutes, less than two minutes, less than one minute, less than twenty seconds, less than one second, less than one tenth of a second, less than one hundredth of a second, less than one millisecond, etc.

Again, generally speaking, and without intending to be limiting, another aspect of the invention relates to methods, apparatus or articles-of-manufacture for performing a job using a peer-to-peer network-connected distributed computing system, the job illustratively comprised of a plurality of tasks, the methods/apparatus/articles-of-manufacture involving, for example, the following: initiating execution of each of the plurality of tasks on a different processor connected to the peer-to-peer computer network; initiating redundant execution of at least one of the plurality of tasks on yet a different processor connected to the peer-to-peer computer network; and once each of the plurality of tasks has been completed by at least one processor, reporting completion of the job via the peer-to-peer computer network. Preferably, at least one of the plurality of tasks that is/are redundantly assigned is/are critical task(s). The methods/apparatus/articles-of-manufacture may further involve monitoring, on a periodic basis, to ensure that progress is being made toward completion of the job. Such monitoring may be performed at least once every five minutes, at least once every two minutes, at least once each minute, at least once every ten seconds, at least once a second, at least once every tenth of a second, at least once every hundredth of a second, at least once every millisecond, etc.

Again, generally speaking, and without intending to be limiting, another aspect of the invention relates to methods, apparatus or articles-of-manufacture for performing a job using a plurality of independent, network-connected processors, the job illustratively comprising a plurality of tasks, the methods/apparatus/articles-of-manufacture involving, for example, the following: assigning each of the plurality of tasks to a different processor connected to the computer network; redundantly assigning at least some, but preferably not all, of the plurality of tasks to additional processors connected to the computer network; and using the computer network to compile results from the assigned tasks and report completion of the job. Redundantly assigning at least some of the plurality of tasks to additional processors may involve assigning critical tasks to additional processors, and preferably involves assigning at least one critical task to at least two processors. The methods/apparatus/articles-of-manufacture may further involve generating a heartbeat message from each processor executing an assigned task, preferably on a regular basis, such as at least once every second, at least once every tenth of a second, at least once every hundredth of a second, at least once every millisecond, etc.

Again, generally speaking, and without intending to be limiting, another aspect of the invention relates to methods, apparatus or articles-of-manufacture for performing a job using a pool of network-connected processors, the job illustratively comprising a plurality of tasks, the number of processors in the pool greater than the number of tasks in the job, the methods/apparatus/articles-of-manufacture involving, for example, the following: assigning each of the plurality of tasks to at least one processor in the pool; redundantly assigning at least some of the plurality of tasks until all, or substantially all, of the processors in the pool have been assigned a task; and using the computer network to compile results from the assigned tasks and report completion of the job. Redundantly assigning at least some of the plurality of tasks preferably includes redundantly assigning a plurality of critical tasks.

Again, generally speaking, and without intending to be limiting, another aspect of the invention relates to methods, apparatus or articles-of-manufacture for using redundancy, in a network-based distributed processing environment, to avoid or mitigate delays from failures and/or slowdowns of individual processing elements, the methods/apparatus/articles-of-manufacture involving, for example, the following: receiving a job request, from a client, over the network; processing the job request to determine the number, K, of individual tasks to be assigned to individual network-connected processing elements; determining a subset, N, of the K tasks whose completion is most critical to the overall completion of the job; and assigning each of the K tasks to an individual network-connected processing element; and redundantly assigning at least some of the N task(s) in the subset to additional network-connected processing element(s). Determining the subset, N, of the K tasks whose completion is most critical to the overall completion of the job may include one or more of the following: (i) assigning, to the subset, task(s) that must be completed before other task(s) can be commenced; (ii) assigning, to the subset, task(s) that supply data to other task(s); (iii) assigning, to the subset, task(s) that is/are likely to require the largest amount of memory; (iv) assigning, to the subset, task(s) that is/are likely to require the largest amount of local disk space; (v) assigning, to the subset, task(s) that is/are likely to require the largest amount of processor time; and/or (vi) assigning, to the subset, task(s) that is/are likely to require the largest amount of data communication over the network. The methods/apparatus/articles-of-manufacture may further involve: determining, based on completions of certain of the K tasks and/or N redundant task(s), that sufficient tasks have been completed to compile job results; and reporting job results to the client over the network.

Again, generally speaking, and without intending to be limiting, another aspect of the invention relates to methods, apparatus or articles-of-manufacture for using a group of network-connected processing elements to process a job, the job illustratively comprised of a plurality of tasks, one or more of which are critical tasks, the methods/apparatus/articles-of-manufacture involving, for example, the following: identifying a one or more higher-capacity processing elements among the group of network-connected processing elements; assigning at least one critical task to at least one of the identified higher-capacity processing elements; assigning other tasks to other processing elements such that each task in the job has been assigned to at least one processing element; and communicating results from the assigned tasks over the network. Identifying a one or more higher-capacity processing elements among the group of network-connected processing elements may involve one or more of the following: (i) evaluating the processing capacity of processing elements in the group based on their execution of previously-assigned tasks; (ii) determining the processing capacity of processing elements in the group through use of assigned benchmark tasks; and/or (iii) evaluating hardware configurations of at least a plurality of processing elements in the group. The methods/apparatus/articles-of-manufacture may further involve (i) ensuring that each critical task in the job is assigned to a higher-capacity processing element and/or (ii) storing the amount of time used by the processing elements to execute the assigned tasks and computing a cost for the job based, at least in part, on the stored task execution times. Computing a cost for the job based, at least in part, on the stored task execution times may involve charging a higher incremental rate for time spent executing tasks on higher-capability processing elements than for time spent executing tasks on other processing elements. Such computed costs are preferably communicated over the network.

Again, generally speaking, and without intending to be limiting, another aspect of the invention relates to methods, apparatus or articles-of-manufacture for distributed computing, including, for example, the following: a multiplicity of worker processors; at least one supervisory processor, configured to assign tasks to, and monitor the status of, the worker processors, the at least one supervisory processor further configured to assign each critical task to at least two worker processors; an always-on, peer-to-peer computer network linking the worker processors and the supervisory processor(s); and at least one of the at least one supervisory processor(s) including a monitoring module, which monitors the status of worker processors expected to be executing assigned tasks to ensure that the distributed computing system maintains always-live operation. The monitoring module preferably receives status messages from at least each of the worker processors expected to be executing assigned tasks, and preferably detects abnormalities in the operation of the worker processors expected to be executing assigned tasks, and/or their associated network connections, by detecting an absence of expected status messages received from the worker processors. The monitoring module checks for an absence of expected status messages at predetermined intervals, such as at least once each minute, at least once each second, etc. Alternatively, or additionally, the monitoring module may be configured to detect the presence of non-assigned-task-related activity on the worker processors expected to be executing assigned tasks, preferably through use activity monitor programs running on each of the worker processors expected to be executing assigned tasks. Such activity monitor programs may comprise screensaver programs, and may be configured to detect one, two, three or more of the following types of non-assigned-task-related activity: keyboard activity; mouse activity; pointer activity; touchscreen activity; voice activity; and/or execution of substantial non-assigned-task-related processes.

Still further aspects of the invention relate to alternative combinations, sub-combinations, supplemental combinations and/or permutations of the various above-described elements and features, as well as those elements and features described in the incorporated '244 and/or '634 applications, consistent with or in furtherance of the objects and spirit of the present invention.

### BRIEF DESCRIPTION OF THE DRAWINGS

Various aspects, features and advantages of the instant invention are depicted in the accompanying set figures, which is intended to be illustrative, rather than limiting, and in which:

FIG. 1 depicts an exemplary network-based distributed processing system in which the present invention may be employed; and,

FIG. 2 is a flowchart illustrating the operation of an exemplary process in accordance with the invention.

### DESCRIPTION OF AN EXEMPLARY EMBODIMENT

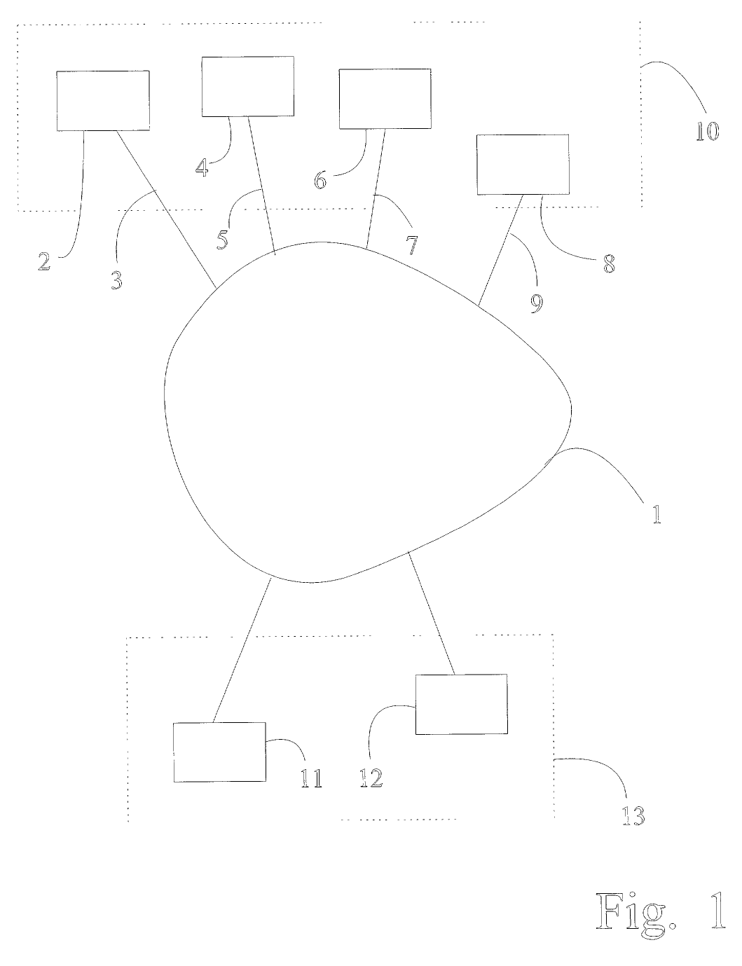

Referring initially to FIG. 1, which depicts an exemplary context in which the method(s), apparatus and/or article(s)-of-manufacture of the invention may be applied, a computer network 1 is shown connecting a plurality of processing resources. (Although, for clarity, only six processing resources are shown in FIG. 1, the invention is preferably deployed in networks connecting hundreds, thousands, tens of thousands or greater numbers of processing resources.) Computer network 1 may utilize any type of transmission medium (e.g., wire, coax, fiber optics, RF, satellite, etc.) and any network protocol. However, in order to realize the principal benefit(s) of the present invention, computer network 1 should provide a relatively high bandwidth (e.g., at least 100 kilobits/second) and preferably, though not necessarily, should provide an “always on” connection to the processing resources involved in distributed processing activities.

Still referring to FIG. 1, one or more supervisory processor(s) 13 may communicate with a plurality of worker processors 10 via computer network 1. Supervisory processor(s) 13 perform such tasks as:

accepting job(s) from clients;

assigning/reassigning tasks to (or among) worker processors;

managing pools of available worker processors;

monitoring the status of worker processors;

monitoring the status of network connections;

monitoring the status of job and task completions;

compiling, maintaining and/or updating statistics on the capabilities and/or past performance of available processing resources; and/or,

resource utilization tracking, timekeeping and billing.

Still referring to FIG. 1, the depicted plurality 13 of supervisory processors 11 and 12 may operate collaboratively as a group, independently (e.g., each handing different job(s), task(s) and/or worker processor pool(s)) and/or redundantly (thus providing enhanced reliability). However, to realize a complete distributed processing system in accordance with the invention, only a single supervisory processor (e.g., 11 or 12) is needed.

Still referring to FIG. 1, plurality 10 of worker processors illustratively comprises worker processors 2, 4, 6 and 8, each connected to computer network 1 through network connections 3, 5, 7 and 9, respectively. These worker processors communicate with supervisory processor(s) 13 via network 1, and preferably include worker processor software that enables substantially continuous monitoring of worker processor status and/or task execution progress by supervisory processor(s) 13.

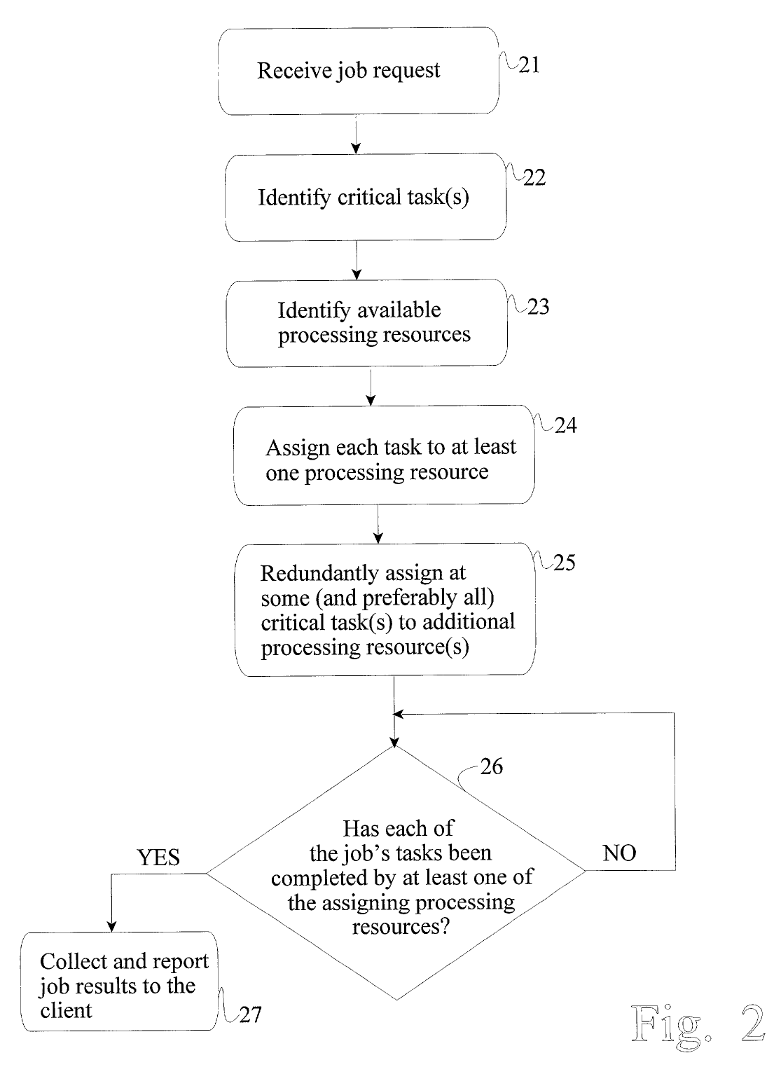

Referring now to FIG. 2, which depicts an exemplary process in accordance with the invention, a job request is received 21 via the computer network. The received job request typically includes a multiplicity of subordinate tasks. The set of tasks is examined or analyzed to identify 22 critical tasks. Such identification 22 of critical tasks may take several forms, including, but by no means limited to, the following:

identifying as critical any task(s) that the client has tagged as critical in the received job request;

using data dependency analysis techniques (like those commonly used in optimizing compilers) to identify critical task(s);

using execution dependency analysis techniques (like those commonly used in compilers and interpreters) to identify critical task(s);

analyzing the operations called for by individual tasks to identify those critical task(s) most likely to demand the greatest processing and/or network resources;

using past performance data for the job-in-question to identify critical task(s); and/or,

any combination of the above, or any combination of the above with other techniques.

Identification 23 of available processing resources includes determining the available pool of potential worker processors, and may also include determining the capabilities (e.g., processor speed, memory, network bandwidth, historical performance) of processing resources in the identified pool. Each task is then assigned 24 to at least one processing element. Such task assignment may optionally involve assigning critical task(s) to higher-capability processing elements. Some (and preferably all) critical task(s) are also assigned 25 to additional (i.e., redundant) processing elements. (Note that although 24 and 25 are depicted as discrete acts, they can be (and are preferably) performed together.)

Task executions are monitored, preferably on a substantially continuous basis, as disclosed in the incorporated '634 application. Once such monitoring reveals that each of the job's tasks has been completed 26 by at least one of the assigned processing resources, then the results are collected and reported 27 to the client.

While the foregoing has described the invention by recitation of its various aspects/features and an illustrative embodiment thereof, those skilled in the art will recognize that alternative elements and techniques, and/or combinations and sub-combinations of the described elements and techniques, can be substituted for, or added to, those described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e.g., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e.g., the claim “a widget comprising: A; B; and C” would be infringed by a device containing 2A's, B, and 3C's; also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”; where, instead, a purely singular meaning is intended, a phrase such as “one,” “only one,” or “a single,” will appear.

Where the phrase “means for” precedes a data processing or manipulation “function,” it is intended that the resulting means-plus-function element be construed to cover any, and all, computer implementation(s) of the recited “function” using any standard programming techniques known by, or available to, persons skilled in the computer programming arts.

A claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claims.

What we claim is:

1. A method for improving quality-of-service in a distributed computing system, said system including a multiplicity of network-connected worker processors and at least one supervisory processor, said supervisory processor configured to assign tasks to said worker processors, said method comprising:
identifying one or more of said tasks as critical task(s);
assigning each of said tasks, including said critical task(s), to a worker processor;
redundantly assigning each of said one or more critical task(s) to a worker processor; and,
monitoring the status of said assigned tasks to determine when all of said tasks have been completed by at least one worker processor.

2. A method for improving quality-of-service in a distributed computing system, as defined in claim 1, further comprising:
monitoring, on a substantially continuous basis, the status of at least the worker processor(s) that have been assigned the non-critical task(s).

3. A method for improving quality-of-service in a distributed computing system, as defined in claim 2, wherein monitoring, on a substantially continuous basis, the status of at least the worker processor(s) that have been assigned the non-critical task(s) comprises receiving status messages from at least each of the worker processor(s) that have been assigned non-critical task(s) until each said processor completes its assigned task.

4. A method for improving quality-of-service in a distributed computing system, as defined in claim 2, wherein monitoring, on a substantially continuous basis, the status of at least the worker processor(s) that have been assigned the non-critical task(s) comprises detecting abnormalities in the operation of the worker processor(s) that have been assigned non-critical task(s), and/or their associated network connections, by detecting an absence of expected status message(s) received by said at least one supervisory processor.

5. A method for improving quality-of-service in a distributed computing system, as defined in claim 4, wherein said act of detecting an absence of expected status message(s) received by said at least one supervisory processor is repeated at least once every ten minutes.

6. A method for improving quality-of-service in a distributed computing system, as defined in claim 4, wherein said act of detecting an absence of expected status message(s) received by said at least one supervisory processor is repeated at least once each minute.

7. A method for improving quality-of-service in a distributed computing system, as defined in claim 4, wherein said act of detecting an absence of expected status message(s) received by said at least one supervisory processor is repeated at least once each second.

8. A method for improving quality-of-service in a distributed computing system, as defined in claim 4, wherein said act of detecting an absence of expected status message(s) received by said at least one supervisory processor is repeated at least once every tenth of a second.

9. A method for improving quality-of-service in a distributed computing system, as defined in claim 2, wherein monitoring, on a substantially continuous basis, the status of at least the worker processor(s) that have been assigned the non-critical task(s) comprises:
detecting the presence of non-assigned-task-related activity on at least said worker processor(s) that have been assigned the non-critical task(s).

10. A method for improving quality-of-service in a distributed computing system, as defined in claim 9, wherein detecting the presence of non-assigned-task-related activity includes:
running an activity monitor program on at least each of the worker processor(s) that have been assigned non-critical task(s).

11. A method for improving quality-of-service in a distributed computing system, as defined in claim 10, wherein:
the activity monitor programs behave substantially like screen saver programs.

12. A method for improving quality-of-service in a distributed computing system, as defined in claim 10, wherein:
the activity monitory programs send, in response to detection of keyboard activity, a message to at least one of said at least one supervisory processor(s).

13. A method for improving quality-of-service in a distributed computing system, as defined in claim 10, wherein:
the activity monitory programs send, in response to detection of mouse activity, a message to at least one of said at least one supervisory processor(s).

14. A method for improving quality-of-service in a distributed computing system, as defined in claim 10, wherein:
the activity monitory programs send, in response to detection of pointer activity, a message to at least one of said at least one supervisory processor(s).

15. A method for improving quality-of-service in a distributed computing system, as defined in claim 10, wherein:
the activity monitory programs send, in response to detection of touchscreen activity, a message to at least one of said at least one supervisory processor(s).

16. A method for improving quality-of-service in a distributed computing system, as defined in claim 10, wherein:
the activity monitory programs send, in response to detection of voice activity, a message to at least one of said at least one supervisory processor(s).

17. A method for improving quality-of-service in a distributed computing system, as defined in claim 10, wherein:
the activity monitory programs send, in response to detection of execution of substantial non-assigned-task-related processes, a message to at least one of said at least one supervisory processor(s).

18. A method for improving quality-of-service in a distributed computing system, as defined in claim 9, wherein detecting the presence of non-assigned-task-related activity includes:
determining, in response to an activity monitor message received by at least one of said at least one supervisory of said processor(s), that at least one of said worker processors is undertaking non-assigned-task-related activity.

19. A method for improving quality-of-service in a distributed computing system, as defined in claim 18, wherein the activity monitor message is generated by an activity monitor program running on one of said assigned worker processors.

20. A method for operating a peer-to-peer distributed computing system, comprising:
providing a pool of worker processors, each having installed worker processor software, and each connected to an always-on, peer-to-peer computer network;
providing at least one supervisory processor, also connected to said always-on, peer-to-peer computer network;
using said at least one supervisory processor to monitor the status of worker processors expected to be engaged in the processing of assigned tasks; and,
using said at least one supervisory processor to redundantly assign one more critical task(s) to one or more additional worker processors.

21. A method for operating a peer-to-peer distributed computing system, as defined in claim 20, wherein providing a pool of worker processors further includes ensuring that each of said worker processors is linked to said always-on, peer-to-peer computer network through a high-bandwidth connection.

22. A method for operating a peer-to-peer distributed computing system, as defined in claim 21, wherein providing a pool of worker processors further includes ensuring that each of said worker processors is linked to said always-on, peer-to-peer computer network at a data rate of at least 100 kilobits/sec.

23. A method for operating a peer-to-peer distributed computing system, as defined in claim 21, wherein providing a pool of worker processors further includes ensuring that each of said worker processors is linked to said always-on, peer-to-peer computer network at a data rate of at least 250 kilobits/sec.

24. A method for operating a peer-to-peer distributed computing system, as defined in claim 21, wherein providing a pool of worker processors further includes ensuring that each of said worker processors is linked to said always-on, peer-to-peer computer network at a data rate of at least 1 megabit/sec.

25. A method for operating a peer-to-peer distributed computing system, as defined in claim 21, wherein providing a pool of worker processors further includes ensuring that each of said worker processors is linked to said always-on, peer-to-peer computer network at a data rate of at least 10 megabits/sec.

26. A method for operating a peer-to-peer distributed computing system, as defined in claim 21, wherein providing a pool of worker processors further includes ensuring that each of said worker processors is linked to said always-on, peer-to-peer computer network at a data rate of at least 100 megabits/sec.

27. A method for operating a peer-to-peer distributed computing system, as defined in claim 21, wherein providing a pool of worker processors further includes ensuring that each of said worker processors is linked to said always-on, peer-to-peer computer network at a data rate of at least 1 gigabit/sec.

28. A method for operating a peer-to-peer distributed computing system, as defined in claim 20, wherein using said at least one supervisory processor to monitor the status of worker processors expected to be engaged in the processing of assigned tasks includes:
sending a status-request message to, and receiving a return acknowledgement from, each worker processor that is expected to be engaged in the processing of assigned tasks.

29. A method for operating a peer-to-peer distributed computing system, as defined in claim 28, wherein said process of sending a status-request message to, and receiving a return acknowledgement from, each worker processor that is expected to be engaged in the processing of assigned tasks is repeated at least once every second.

30. A method for operating a peer-to-peer distributed computing system, as defined in claim 28, wherein said process of sending a status-request message to, and receiving a return acknowledgement from, each worker processor that is expected to be engaged in the processing of assigned tasks is repeated at least once every tenth of a second.

31. A method for operating a peer-to-peer distributed computing system, as defined in claim 28, wherein said process of sending a status-request message to, and receiving a return acknowledgement from, each worker processor that is expected to be engaged in the processing of assigned tasks is repeated at least once every hundredth of a second.

32. A method for operating a peer-to-peer distributed computing system, as defined in claim 28, wherein said process of sending a status-request message to, and receiving a return acknowledgement from, each worker processor that is expected to be engaged in the processing of assigned tasks is repeated at least once every millisecond.

33. A method for operating a peer-to-peer distributed computing system, as defined in claim 20, wherein using said at least one supervisory processor to monitor the status of worker processors expected to be engaged in the processing of assigned tasks includes:
periodically checking to ensure that a heartbeat message has been received, within a preselected frequency interval, from each worker processor that is expected to be engaged in the processing of assigned tasks.

34. A method for operating a peer-to-peer distributed computing system, as defined in claim 33, wherein said preselected frequency interval is less than one second.

35. A method for operating a peer-to-peer distributed computing system, as defined in claim 33, wherein said preselected frequency interval is less than one tenth of a second.

36. A method for operating a peer-to-peer distributed computing system, as defined in claim 33, wherein said preselected frequency interval is less than one hundredth of a second.

37. A method for operating a peer-to-peer distributed computing system, as defined in claim 33, wherein said preselected frequency interval is less than one millisecond.

38. A method for performing a job using a peer-to-peer network-connected distributed computing system, the job comprising a plurality of tasks, the method comprising:
initiating execution of each of said plurality of tasks on a different processor connected to said peer-to-peer computer network;
initiating redundant execution of at least one of said plurality of tasks on yet a different processor connected to said peer-to-peer computer network; and,
once each of said plurality of tasks has been completed by at least one processor, reporting completion of said job via said peer-to-peer computer network.

39. A method for performing a job using a peer-to-peer network-connected distributed computing system, as defined in claim 38, wherein said at least one of said plurality of tasks that is/are redundantly assigned is/are critical task(s).

40. A method for performing a job using a peer-to-peer network-connected distributed computing system, as defined in claim 38, further comprising:
monitoring, on a periodic basis, to ensure that progress is being made toward completion of said job.

41. A method for performing a job using a peer-to-peer network-connected distributed computing system, as defined in claim 40, wherein said monitoring is performed at least once every 10 seconds.

42. A method for performing a job using a peer-to-peer network-connected distributed computing system, as defined in claim 40, wherein said monitoring is performed at least once a second.

43. A method for performing a job using a peer-to-peer network-connected distributed computing system, as defined in claim 40, wherein said monitoring is performed at least once every tenth of a second.

44. A method for performing a job using a peer-to-peer network-connected distributed computing system, as defined in claim 40, wherein said monitoring is performed at least once every hundredth of a second.

45. A method for performing a job using a peer-to-peer network-connected distributed computing system, as defined in claim 40, wherein said monitoring is performed at least once every millisecond.

46. A method for performing a job using a plurality of independent, network-connected processors, the job comprising a plurality of tasks, the method comprising:
assigning each of said plurality of tasks to a different processor connected to said computer network;
redundantly assigning at least some, but not all, of said plurality of tasks to additional processors connected to said computer network; and,
using said computer network to compile results from the assigned tasks and report completion of the job.

47. A method, as defined in claim 46, wherein redundantly assigning at least some of said plurality of tasks to additional processors comprises assigning critical tasks to additional processors.

48. A method, as defined in claim 46, wherein redundantly assigning at least some of said plurality of tasks to additional processors comprises assigning at least one critical task to at least two additional processors.

49. A method, as defined in claim 46, further comprising:
generating a heartbeat message from each processor executing an assigned task at least once every second.

50. A method, as defined in claim 46, further comprising:
generating a heartbeat message from each processor executing an assigned task at least once every tenth of a second.

51. A method, as defined in claim 46, further comprising:
generating a heartbeat message from each processor executing an assigned task at least once every hundredth of a second.

52. A method, as defined in claim 46, further comprising:
generating a heartbeat message from each processor executing an assigned task at least once every millisecond.

53. A method for performing a job using a pool of network-connected processors, the job comprising a plurality of tasks, the number of processors in the pool greater than the number of tasks in the job, the method comprising:
assigning each of said plurality of tasks to at least one processor in said pool;
redundantly assigning at least some of said plurality of tasks until all, or substantially all, of said processors in said pool have been assigned a task; and,
using said computer network to compile results from the assigned tasks and report completion of the job.

54. A method, as defined in claim 53, wherein redundantly assigning at least some of said plurality of tasks includes redundantly assigning a plurality of critical tasks.

55. A method for using redundancy in a network-based distributed processing system to avoid or mitigate delays from failures and/or slowdowns of individual processing elements, the method comprising:
receiving a job request, from a client, over the network;
processing the job request to determine the number, K, of individual tasks to be assigned to individual network-connected processing elements;
determining a subset, N, of said K tasks whose completion is most critical to the overall completion of the job; and,
assigning each of said K tasks to an individual network-connected processing element; and,
redundantly assigning at least some of the N task(s) in said subset to additional network-connected processing element(s).

56. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that must be completed before other task(s) can be commenced.

57. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that supply data to other task(s).

58. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that is/are likely to require the largest amount of memory.

59. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that is/are likely to require the largest amount of local disk space.

60. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that is/are likely to require the largest amount of processor time.

61. A method, as defined in claim 55, for using redundancy in a network-based distributed processing system to avoid or mitigate delays from failures and/or slowdowns of individual processing elements, wherein determining the subset, N, of said K tasks whose completion is most critical to the overall completion of the job includes assigning, to the subset, task(s) that is/are likely to require the largest amount of data communication over the network.

62. A method, as defined in claim 55, for using redundancy in a network-based distributed processing system to avoid or mitigate delays from failures and/or slowdowns of individual processing elements, further comprising:
determining, based on completions of certain of said K tasks and/or N redundant task(s), that sufficient tasks have been completed to compile job results; and,
reporting job results to the client over the network.

63. A method for using a group of network-connected processing elements to process a job, the job comprised of a plurality of tasks, one or more of which are critical tasks, the method comprising:
identifying a one or more higher-capacity processing elements among said group of network-connected processing elements;
assigning at least one critical task to at least one of the identified higher-capacity processing elements;
assigning other tasks to other processing elements such that each task in said job has been assigned to at least one processing element; and,
communicating results from said assigned tasks over said network.

64. A method for using a group of network-connected processing elements to process a job, as defined in claim 63, wherein identifying a one or more higher-capacity processing elements among said group of network-connected processing elements includes evaluating the processing capacity of processing elements in said group based on their execution of previously-assigned tasks.

65. A method for using a group of network-connected processing elements to process a job, as defined in claim 63, wherein identifying a one or more higher-capacity processing elements among said group of network-connected processing elements includes determining the processing capacity of processing elements in said group through use of assigned benchmark tasks.

66. A method for using a group of network-connected processing elements to process a job, as defined in claim 63, wherein identifying a one or more higher-capacity processing elements among said group of network-connected processing elements includes evaluating hardware configurations of at least a plurality of processing elements in said group.

67. A method for using a group of network-connected processing elements to process a job, as defined in claim 63, further comprising:
ensuring that each critical task in the job is assigned to a higher-capacity processing element.

68. A method for using a group of network-connected processing elements to process a job, as defined in claim 63, further comprising:
storing the amount of time used by said processing elements to execute the assigned tasks; and,
computing a cost for said job based, at least in part, on said stored task execution times.

69. A method for using a group of network-connected processing elements to process a job, as defined in claim 68, wherein computing a cost for said job based, at least in part, on said stored task execution times includes charging a higher incremental rate for time spent executing tasks on higher-capability processing elements than for time spent executing tasks on other processing elements.

70. A method for using a group of network-connected processing elements to process a job, as defined in claim 68, further comprising:
communicating the computed cost for said job over said network.

71. A distributed computing system comprising:
a multiplicity of worker processors;
at least one supervisory processor, configured to assign tasks to, and monitor the status of, said worker processors, said at least one supervisory processor further configured to assign each critical task to at least two worker processors;
an always-on, peer-to-peer computer network linking said worker processors and said supervisory processor(s); and,
at least one of said at least one supervisory processor(s) including a monitoring module, which monitors the status of worker processors expected to be executing assigned tasks to ensure that the distributed computing system maintains always-live operation.

72. A distributed computing system, as defined in claim 71, wherein the monitoring module receives status messages from at least each of the worker processors expected to be executing assigned tasks.

73. A distributed computing system, as defined in claim 72, wherein the monitoring module detects abnormalities in the operation of said worker processors expected to be executing assigned tasks, and/or their associated network connections, by detecting an absence of expected status messages received from said worker processors.

74. A distributed computing system, as defined in claim 73, wherein the monitoring module checks for an absence of expected status messages at least once each minute.

75. A distributed computing system, as defined in claim 73, wherein the monitoring module checks for an absence of expected status messages at least once each second.

76. A distributed computing system, as defined in claim 72, wherein the monitoring module detects the presence of non-assigned-task-related activity on the worker processors expected to be executing assigned tasks.

77. A distributed computing system, as defined in claim 76, further comprising:
activity monitor programs running on each of the worker processors expected to be executing assigned tasks.

78. A distributed computing system, as defined in claim 77, wherein the activity monitor programs comprise screensaver programs.

79. A distributed computing system, as defined in claim 77, wherein the activity monitor programs detect at least one of the following types of non-assigned-task-related activity:
keyboard activity;
mouse activity;
pointer activity;
touchscreen activity;
voice activity; and,
execution of substantial non-assigned-task-related processes.

80. A distributed computing system, as defined in claim 77, wherein the activity monitor programs detect at least two of the following types of non-assigned-task-related activity:
keyboard activity;
mouse activity;
pointer activity;
touchscreen activity;
voice activity; and,
execution of substantial non-assigned-task-related processes.
